(19) United States
(12) Patent Application Publication
(10) Pub. No.: US 2016/0092493 A1
(43) Pub. Date: Mar. 31, 2016

(54) EXECUTING MAP-REDUCE JOBS WITH NAMED DATA

(71) Applicant: International Business Machines Corporation, Armonk, NY (US)

(72) Inventors: Bong Jun KO, Harrington Park, NJ (US); Vasileios PAPPAS, New York, NY (US); Robert D. GRANDL, Redmond, WA (US)

(21) Appl. No.: 14/499,725

(22) Filed: Sep. 29, 2014

(51) Int. Cl. G06F 17/30

(52) U.S. Cl. CPC G06F 17/30371; G06F 17/30318; G06F 17/30339

(57) ABSTRACT

Various embodiments execute MapReduce jobs. In one embodiment, at least one MapReduce job is received from one or more user programs. At least one input file associated with the MapReduce job is divided into a plurality of data blocks each including a plurality of key-value pairs. A first unique name is associated with each of the data blocks. Each of a plurality of mapper nodes generates an intermediate dataset for at least one of the plurality of data blocks. A second unique name is associated with the intermediate dataset generated by each of the plurality of mapper nodes. The second unique name is based on at least one of the first unique name, a set of mapping operations performed on the at least one of the plurality of data blocks, and a number associated with a reducer node in a set of reducer nodes assigned to the intermediate dataset.

### BACKGROUND

The present disclosure generally relates to parallel and distributed data processing, and more particularly relates to executing MapReduce jobs with named data.

The emergence of smarter planet applications in the era of big-data calls for smarter data analytics platforms. These platforms need to efficiently handle an ever-increasing volume of data generated from a variety of sources and also alleviate the excessive requirements for processing and networking resources.

### BRIEF SUMMARY

In one embodiment, a method to execute MapReduce jobs is disclosed. The method comprises receiving, by one or more processors, at least one MapReduce job from one or more user programs. At least one input file associated with the MapReduce job is divided into a plurality of data blocks each comprising a plurality of key-value pairs. A first unique name is associated with each of the plurality of data blocks. Each of a plurality of mapper nodes generates an intermediate dataset for at least one of the plurality of data blocks. The intermediate dataset comprises at least one list of values for each of a set of keys in the plurality of key-value pairs. A second unique name is associated with the intermediate dataset generated by each of the plurality of mapper nodes. The second unique name is based on at least one of the first unique name associated with the at least one of the plurality of data blocks, a set of mapping operations performed on the at least one of the plurality of data blocks to generate the intermediate dataset, and a number associated with a reducer node in a set of reducer nodes assigned to the intermediate dataset.

In another embodiment, a MapReduce system for executing MapReduce jobs is disclosed. The MapReduce system comprises one or more information processing systems. The one or more information processing systems comprise memory and one or more processors communicatively coupled to the memory. The one or more processors being configured to perform a method. The method comprises receiving, by one or more processors, at least one MapReduce job from one or more user programs. At least one input file associated with the MapReduce job is divided into a plurality of data blocks each comprising a plurality of key-value pairs. A first unique name is associated with each of the plurality of data blocks. Each of a plurality of mapper nodes generates an intermediate dataset for at least one of the plurality of data blocks. The intermediate dataset comprises at least one list of values for each of a set of keys in the plurality of key-value pairs. A second unique name is associated with the intermediate dataset generated by each of the plurality of mapper nodes. The second unique name is based on at least one of the first unique name associated with the at least one of the plurality of data blocks, a set of mapping operations performed on the at least one of the plurality of data blocks to generate the intermediate dataset, and a number associated with a reducer node in a set of reducer nodes assigned to the intermediate dataset.

In yet another embodiment, a computer program product for executing MapReduce jobs is disclosed. The computer program product comprises a storage medium readable by a processing circuit and storing instructions for execution by the processing circuit for performing a method. The method comprises receiving, by one or more processors, at least one MapReduce job from one or more user programs. At least one input file associated with the MapReduce job is divided into a plurality of data blocks each comprising a plurality of key-value pairs. A first unique name is associated with each of the plurality of data blocks. Each of a plurality of mapper nodes generates an intermediate dataset for at least one of the plurality of data blocks. The intermediate dataset comprises at least one list of values for each of a set of keys in the plurality of key-value pairs. A second unique name is associated with the intermediate dataset generated by each of the plurality of mapper nodes. The second unique name is based on at least one of the first unique name associated with the at least one of the plurality of data blocks, a set of mapping operations performed on the at least one of the plurality of data blocks to generate the intermediate dataset, and a number associated with a reducer node in a set of reducer nodes assigned to the intermediate dataset.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a staging diagram of a MapReduce system according to one embodiment of the present disclosure;

FIG. 3 is an execution flow diagram for a MapReduce system based on a Pull Execution Model according to one embodiment of the present disclosure;

FIG. 4 is a diagram illustrating a communication model between the different components of a MapReduce system when using HTTP according to one embodiment of the present disclosure;

FIGS. 5-6 are operational flow diagrams illustrating one example of a process for executing a MapReduce job according to one embodiment of the present disclosure; and

FIG. 7 is a block diagram illustrating one example of an information processing system according to one embodiment of the present disclosure.

### DETAILED DESCRIPTION

The ability to process and analyze large datasets, often called big-data, is attracting a lot of attention due to its wide applicability in today's society. The central piece of any big-data application is its computational platform, which enables scalable data storage and processing. However, conventional platforms that allow for parallel processing of large amounts have various drawbacks. For example, many conventional platforms are designed for data processing applications that run within a data-center. These platforms assume that all data, under processing, is stored in a locally available file system. This design choice limits the platforms' applicability in a wide range of emerging applications that analyze data generated outside of conventional data-centers. Smarter planet applications require analysis for large volumes of data produced by dispersed data sources, such as sensors, cameras, vehicles, smart phones, etc. However, using many conventional platforms for such applications usually requires transferring and storing the large datasets into a data-center for further processing. This can be largely inefficient due to sheer size of the data and its transient nature, or sometimes impossible due to privacy and legislative constraints.

In addition, many of the conventional platforms fail to provide any mechanisms for eliminating redundant computations. Many applications generate datasets that are often subjected to analysis carried out repeatedly over time. For example, monitoring and performance data generated by network management systems are processed multiple times over a moving time-window and at different time-scales. For such applications, it is desirable to be able to reuse final or intermediate results that have been previously computed by the same or other applications. This way, redundant data transfers and processing can be eliminated.

Therefore, one or more embodiments provide a MapReduce computing platform that performs parallel and distributed data processing of large datasets across a collection (e.g., a cluster or grid) of information processing system (nodes). In one embodiment, the computational platform enables universal data access. For example, MapReduce jobs can access and process data in any location such as in the Internet-scale, e.g., in multiple data-centers, or at the data source origin. Therefore, the need for transferring all data to a central location before being able to process data is eliminated. One or more embodiments also provide for computation reusability were intermediate data produced at various stages of a MapReduce job are made available for reuse by other jobs. This reduces the data transfer and computation time of tasks that share, fully or partially, any input data. Also, embodiments of the present disclosure can be implemented within existing MapReduce systems without any modifications to the existing infrastructure.

The MapReduce system of one or more embodiments implements information-centric networking such that any communication of information between network nodes takes place based on the identifiers, or names, of the data, rather than the locations or identifiers of the nodes. Each piece of data (input data, intermediate output from map tasks, output from reduce tasks) carries a globally-assigned name and can be accessed by any computational tasks. Computational tasks retrieve their input data by using the names of the output data of the previous stage computational tasks. Individual tasks are able to utilize the previously generated data cached at nearby locations. This is especially beneficial for jobs running on a geographically dispersed set of data because of reduced data transfer delay, which in turn has the effect of improving the job completion time in conjunction with the reduced data processing time (due to the elimination of redundant computations).

Operating Environment

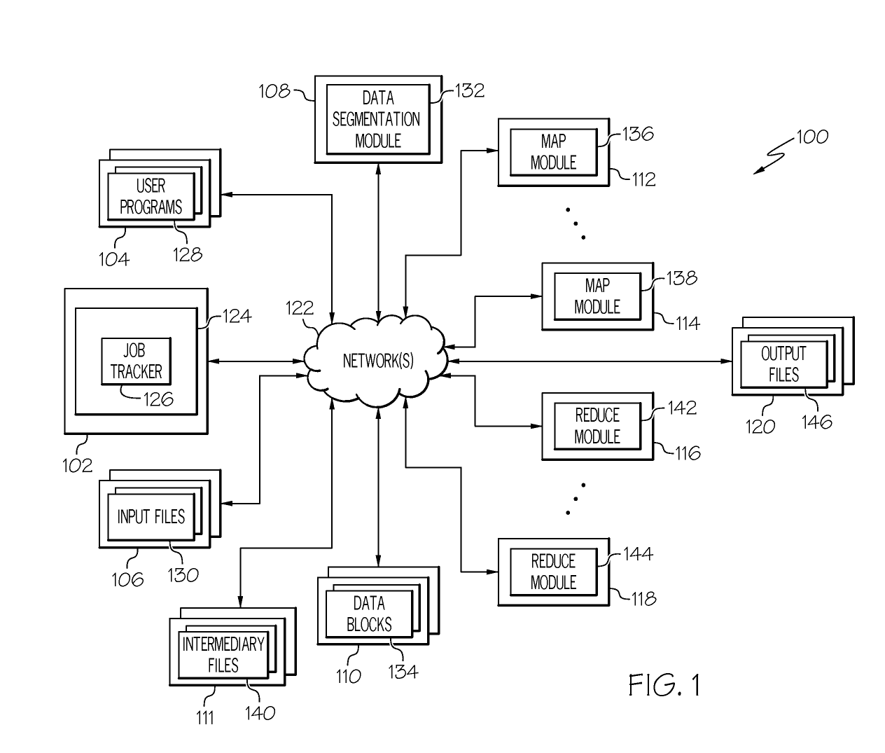

FIG. 1 shows one example of an operating environment 100 for executing MapReduce jobs with named data. In the example shown in FIG. 1, the operating environment 100 comprises a plurality of information processing systems 102 to 120. Each of the information processing systems 102 to 120 is communicatively coupled to one or more networks 122 comprising connections such as wire, wireless communication links, and/or fiber optic cables. In one embodiment, the information processing systems comprise a master node 102, worker nodes 112 to 118, data nodes 106, 110, 120, one or more data segmentation nodes 108, and one or more user nodes 104. The master node 102, worker nodes 112 to 118, data nodes 106, 110, 120, and data segmentation node(s) 108 form a MapReduce system that performs parallel and distributed data processing of large datasets across a collection (e.g., a cluster or grid) of information processing system (nodes).

The master node 102 comprises a MapReduce engine 124 that includes a job tracker 126. One or more user programs 128 submit a MapReduce job to the MapReduce engine 124. In one embodiment, a MapReduce job is an executable code, implemented by a computer programming language (e.g., Java, Python, C/C++, etc.), and submitted to the MapReduce system by the user. A MapReduce job is further divided into a Map job and a Reduce job, each of which is an executable code. The MapReduce job is associated with one or more input file(s) 130, which store data on which MapReduce operations are to be performed. MapReduce jobs can access and process data in any locations. For example, the data can be stored and accessed at one or more file systems, databases, multiple data centers, at the data source origin, and/or the like. The data can reside at one information processing system 106 or be distributed across multiple systems.

The job tracker 126 manages MapReduce jobs and the MapReduce operations that are to be performed thereon. For example, the job tracker 126 communicates with a data segmentation module 132 that splits the input data into multiple blocks 134, which are then stored on one or more data storage nodes 110. It should be noted that the data segmentation module 132 can be part of the user program 128 or reside on a separate information processing system(s) 132. The job tracker 126 selects a plurality of worker nodes 112 to 118 comprised of mapper nodes and reducer nodes to perform MapReduce operations on the data blocks 134. In particular, a map module 136, 138 at each selected mapper node 112, 114 performs the mapping operations by executing the Map job on a data block(s) to produce an intermediary file(s) 140 (also referred to herein as “mapper output 140” or “mapper output file 140”), which are subsequently stored on one or more data storage nodes 111. The mapping operation performed by each mapper node is referred to as a Map “task”. A reduce module 142, 144 at each selected reducer node 116, 118 performs reducing operations by executing the Reduce job on an intermediary file(s) 140 produced by the mapper nodes 112, 114 and generates an output file 146 (also referred to herein as “MapReduce results 146” or “reducer output 146”) comprising the result of the reducing operation(s). The reducing operation performed by each reducer node is referred to as a Reduce “task”. The output files 146 are stored on one or more data storage nodes 120 and are combined to produce the final MapReduce job result.

Naming Data for MapReduce Jobs

As will be discussed in greater detail below, various embodiments enable the reuse of previous MapReduce computations without the need of a centralized memorization component. This allows for a fully distributed MapReduce system that scales better with the number of nodes and the size of the data. Also, these embodiments enable the introduction of network caching components that can reduce the I/O and network load of the core MapReduce system. In at least one embodiment, the MapReduce system implements a Named Data model where the system appropriately names the data produced and consumed at each stage of MapReduce computations. For example, the MapReduce system names the input data blocks, the intermediate outputs of the map computations, and the final outputs of the reduce computations. The assigned names enable a unique identification of the data in the various stages of the MapReduce system given the input data and the type of the MapReduce computation.

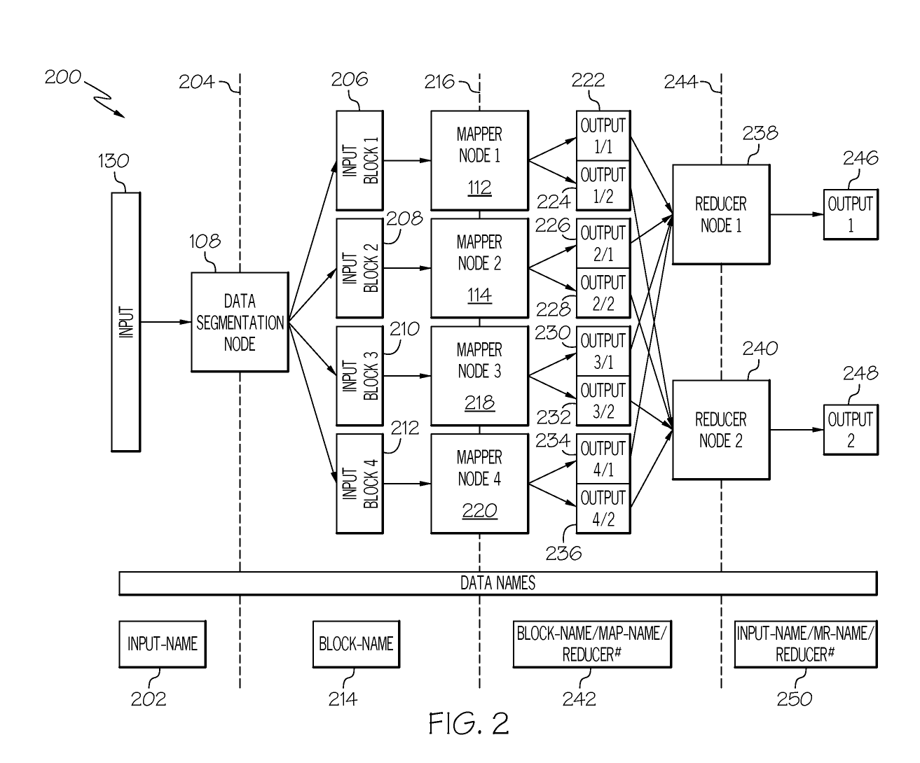

FIG. 2 shows a staging diagram 200 of the MapReduce system and the naming format utilized by the MapReduce system at each stage. In one embodiment, a user program(s) 128 submits a MapReduce job to the MapReduce engine 124, which is associated with an input name 202. The input name comprises the name of an input file(s) 130 associated with the job and a name of the MapReduce job itself. The MapReduce job can also be associated with optional information such as resource availability information identifying the available work nodes (mapper and reducer nodes); the type of input associated with the job; and an identification of the method requested to be used for splitting the input data.

The job tracker 126 sends a request to the data segmentation node 108 to split the input data/file(s) 130 into multiple blocks based on the input name 202 and the optional information regarding the input type and requested split method. If the same input data has been previously split for another job, the job tracker 126 already has the block names and does not request for the input data to be split again. During the data segmentation stage 204, the data segmentation module 132 at the node 108 splits the data into M different data blocks 206 to 212 based on the type of data, the structure of the data and/or the contents of the data. For example, if the input data is a set of text files the segmentation module 132 can divide the original input file 130 into blocks 206 to 212 that have the same number of lines (e.g. 1 million lines for each block). In another example, if the input file 130 is a binary file of records, the segmentation module 132 split results into blocks 206 to 212 with equal number of records. In a yet another example, if the input file 130 is a time series of records the segmentation module 132 splits the file 130 into blocks 206 to 212 with records belonging to the same time windows (e.g., a one hour window). It should be noted that if the input file 130 is an unstructured file, the split can be performed based on the contents of the file, e.g., at file/data points produced by markers based on rolling hash functions such as the Rabin or the cyclic polynomial functions.

Once the data blocks 206 to 212 have been generated, the data segmentation module 132 identifies each of the blocks based on their content. Stated differently, each block 206 to 212 of the input file 130 is assigned a name 214 that is generated based on the data of the block (as compared to being based on the name of its input file); the offset of the input file at which the block starts; and by the length of the block. For example, the name of the block can be a digest such as the SHA1 or MD5 digest of the data block. This naming mechanism enables the reuse of the data block across different input files 130 that happen to have overlapping content. Once the segmentation module 132 has assigned a name to each block 206 to 212, the module 132 returns the names of all the blocks 206 to 212 to the job tracker 126. The segmentation module 132 also stores each of data blocks 206 to 212 at one or more data storage nodes 110.

During the mapping stage 216, each mapper node 112, 114, 218, 220 assigned to a map job/task by the job tracker 126 takes a subset of the data blocks 206 to 212. The map modules 136, 138 at each node perform a plurality of mapping specific computations. For example, a map module 136 parses key/value pairs out of a data block and performs a mapping function that generates and maps the initial key/value pairs to intermediate key/value pairs. Each map module produces an output file 222 to 236 for each combination of data block and reducer node 238, 240 assigned to the MapReduce job. For example, if there are 100 data blocks and 4 reducer nodes for the MapReduce job there are 400 mapper output files (intermediary files) produced by all the mapper modules assigned to the MapReduce job at the end of the mapping stage. Most conventional MapReduce systems generate fewer output files during the mapping stage. This is because all mapper node output data corresponding to the different reducer nodes is generally appended into the same file and then special markers such as offsets within the file are used to distinguish the data belonging to different reducer nodes. However, in one or more embodiments, there is a one-to-one mapping of data blocks and reducer nodes.

In addition, most conventional MapReduce systems identify the output of the mapping stage based on the task identifier of the mapper producing the mapping output and the reducer that requests this output. This approach limits the reuse of mapper results that might have been produced in the past based on the same input file or even different input files that have common data blocks since the task identifier does not relate with either the input file (or data block) or with the type of MapReduce computation. However, in one or more embodiments, each mapper output file 222 to 236 produced during the mapping stage (which corresponds to a unique pair of data block and reducer node) is assigned a unique name 242. In this embodiment, the name 242 is a unique tuple comprising the name of the data block, the name of the map job/task, and the number of the reducer node associated with the mapper output file.

The name of the data block is the name 214 produced by the data segmentation module 132. The name of the map job uniquely identifies the type of map computation that was performed on the data block by its mapper node. In one embodiment, the mapper node utilizes a digest such as the SHA1 or MD5 digest of the executable code of the map job to produce a unique name for map job that uniquely identifies its computation. Therefore, different map jobs (and different versions of the same map job) are identified by different names. Alternatively, the job tracker 126 can maintain the type and version of the map job submitted by the user program 128 and use such information as meta-data to name the map job. The number of the reducer node identifies a segment of the mapper output to be sent to a reducer. For example, when there are four reducer nodes assigned to the MapReduce job, the reducer nodes are numbered 0, 1, 2, and 3, respectively. If the number of reducer nodes is not known in advance or changes from one job to another, a maximum number of reducer nodes is used for naming purposes. If the actual number of reducer nodes is smaller than the maximum, then each reducer node takes an equal share of the mapper outputs. For example, if the maximum number of reducer nodes is 256 and the actual number of reducer nodes is 2 then the first reducer is assigned all the odd numbered mapper output files corresponding to the maximum of 256 reducers while the second reducer node is assigned all the even number mapper output files corresponding to the maximum.

During the reducing stage 244, each reducer node 238, 240 assigned to a reducer job/task by the job tracker 136 performs reducer specific computations on the mapper output files 222 to 236 associated therewith. For example, the reduce module 142, 144 at each reducer node 238, 240 sorts its mapper output files by their intermediate key, which groups all occurrences of the same key together. The reduce module 142, 144 iterates over the sorted intermediate data and combines intermediate data with the same key into one or more final values 246, 248 for the same output key. The reduce module 142, 144 then assigns a unique name 250 to each of its generated outputs 246, 248. In one embodiment, the reducer output name 250 is a tuple of all data block names 214, the name of the map job, the name of the reduce job, and the number of the reducer module responsible for generating the reducer output, where the name of both the reduce job is created by calculating a digest such as the SHA1 or MD5 digest of the executable code of the reducer job. The tuple of the name of the map job and the name of the reduce job comprises the MapReduce job name. This mechanism for naming reducer output enables the reuse of the reducer output whenever the same computation is executed on the same input.

Executing MapReduce Jobs with Named Data

In addition to the Named Data mode one or more embodiments also implement a Pull Execution model (as compared to a Push Execution model). In one embodiment, instead of starting the map computations first and then, once completed, starting the reduce computations, the MapReduce system the reduce computations first. These reduce computations become responsible for identifying the intermediate outputs that already exist as well as the ones that have not been produced. Then, new map computations are executed only for producing the outputs that do not already exist. An HTTP Communication model, or any other communication model that provides equivalent communication functionalities, is also implemented by the MapReduce system where HTTP is utilized to name and retrieve all output data produced in any of the computation stages (e.g., splitter data, mapper data, and reducer data). The HTTP Communication model in combination with the Named Data model enables the introduction of new networking components into the MapReduce system such as web caches that were not previously possible. These components reduce the I/O and network load of the MapReduce system and enable MapReduce deployments outside of data centers. It should be noted that existing MapReduce applications are able to run unmodified in the MapReduce system of one or more embodiments.

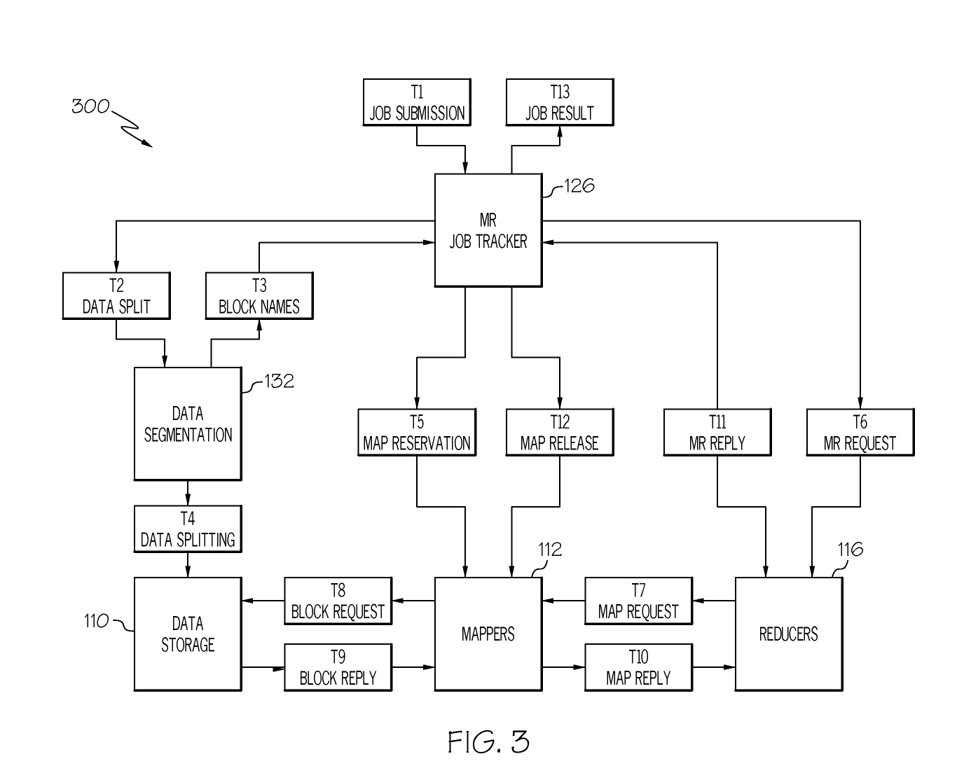

FIG. 3 shows an execution flow 300 for the MapReduce system according the Pull Execution model of one or more embodiments. It should also be noted that embodiments of the present disclosure are not limited to the ordering of events shown in FIG. 3. For example, two or more of the operations discussed below can be performed in parallel and/or can be interleaved. As shown, a user program 128 submits a MapReduce job to the map reduce engine 124, at T1. The job is associated with an input name comprising the name of an input file(s) 130 associated with the job, a name of the MapReduce job itself, and optional information discussed above. The job tracker 126 sends a data split request to the data segmentation module 132, at T2. The data split request is based on the input name associated with the MapReduce job and the optional information regarding the input type and split method. If the same input data has been previously split and the job tracker 126 already has the block names, the job tracker 126 does not send a request to the segmentation module 132.

Once the data segmentation module 132 splits the input into data blocks and generates names for each block, the module 132 sends the names to the job tracker 126, at T3. The data segmentation module 132 also stores the generated data blocks at one or more data storage nodes 110, at T4. The job tracker 126 “reserves” the map task(s) at one or more mapper nodes 112, 114 at T5. In one embodiment, when a map task is reserved on a mapper node, the mapper node does not perform the map task immediately; rather it waits until explicitly requested to be performed by the map task by a reducer node. The association between the identifier (or the network address) of the mapper node and the output data name of each map task reserved on the mapper node can then be announced in the network using a variety of mechanisms, so that other nodes (e.g., reducer nodes), can identify the mapper node responsible for generating a given map task output data in the later stage of Pull-based MapReduce job execution. For example, a name resolution service such as Domain Name System (DNS) can be used by the mapper node to announce the names of the output data it is responsible for generating, and by the reducer nodes to resolve the address of the mapper node based on the name of the map task output data it requires as input. Alternatively, an Information-Centric Network (ICN) can be used to announce the data names to ICN routers, which route the request for the data name issued by other nodes to the nodes.

The job tracker 126 communicates with one or more reducer nodes 116, 118 and requests that the reducer nodes 116, 118 produce the MapReduce results 146 for the MapReduce job, at T6. In one embodiment, this request is issued with the tuple of the input name of associated with the MapReduce job, the names of the data blocks, the name of map job, the name of the reduce job, and the number of reducer node. In other words, the request is uniquely identified by the name of the output that the reducer is being requested to generate 146.

Each reducer node 116, 118 that receives a MapReduce results request from the job tracker 126 retrieves all mapper outputs 140 for the job that it needs to receive as the input to the reduce task, by taking the reducer number, the name of map job, and the data block names in the MapReduce results request. A mapper output 140 can be retrieved either by triggering a new mapper computation or by accessing an already computed and cached copy of the mapper output 140. For example, a reducer node 116, 118 identifies a mapper(s) node 112, 114 that generated the required mapper output file(s) 140 from the mapper output name(s) in the MapReduce request received from the job tracker 126. The reducer node 116, 118 then sends a map request comprising the mapper output name(s) of the required mapper output file(s) 140 to the identified mapper 112, 114 node(s), at T7. If the required mapper output file has been previously generated by some mapper node and exists in the system, a map request by the reducer is served by a node that holds that mapper output file. In one embodiment, the node that holds the intermediary mapper output file 140 can be the mapper node that originally generated the output, a file system node that stores the intermediary data, or some other nodes in the network that opportunistically stores transient data in the network (e.g., data cache). If a required mapper output has not yet been created and hence does not exist in the system, the map request by the reducer is sent to and served by the mapper node that is responsible for generating the mapper output. For example, upon reception of a map request by any reducer node, the mapper node executes the map task reserved on it, generates output, and sends the output to the reducer node that requested it. This intermediary output data 140 can be stored in the network by, for example, the mapper node that generated the output, the reducer node that consumes the mapper output, a file system node, a network cache (e.g., Web cache), and/or the like.

Whether or not a mapper output already exists in the system can be determined either explicitly or implicitly. In an explicit process, the node that stores the intermediary output data 140 announces the name of the data and its network address through a name resolution service such as DNS or ICN and the reducer node determines the existence of the data by querying the name resolution service. In an implicit process, the reducer does not explicitly attempt to determine the existence of the required output, but sends the map request towards the responsible mapper node. The request is served by any node in the network that holds the requested data (e.g., HTTP proxy caches placed en-route from the reducer node to the mapper node, or ICN nodes that store the cached copy of data that pass through them), on behalf of the mapper node.

When a mapper node 112, 114 receives a map request from a reducer node 116, 118, the mapper node 112, 114 analyzes the map request and identifies the mapper output name(s) within the request. The mapper node 112, 114 retrieves the mapper output file(s) 140 corresponding to the mapper output name(s) from a local cache or local/remote storage mechanism. The mapper node 112, 114 then sends a map reply message back to the reducer node comprising the requested the intermediary file(s), at T10. If the mapper node 112, 114 has not already created the mapper output file(s) 140, the mapper node 112, 114 sends a block request comprising the data block name or the required data block(s) to one or more storage nodes 110, at T8. In one embodiment, the mapper node 112, 114 obtains the data block name from the mapper output name within the map request received from the reducer node 116, 118. The data storage node 110 identifies the required data block based on the data block name and sends the data block to the mapper node 112, 114. It should be noted that, in another embodiment, the mapper node 112, 114 retrieves a copy required data block from a local cache. The mapper node 112, 114 performs the required mapping computation on the data block and names the resulting mapper output 140. The mapper node 112, 114 then sends a map reply message to the reducer node comprising the intermediary file, at T10.

After collecting all mapper output data specified in the MapReduce request, each reducer node 116, 118 performs its reduce operations on the mapper output data 140 to generate a set of MapReduce results 146, as discussed above. Each reducer node 116, 118 then sends its MapReduce results 146 to the job tracker 126, at T11. Once the job tracker 126 receives MapReduce results 146 from all the reducer nodes 116, 118 associated with the MapReduce job, the job tracker 126 releases all the map task reservations on the mapper nodes, at T12. The job tracker 126 combines all of the MapReduce results 146 together to produce the final MapReduce job results and reports these results back to the user program 128, at T13. The user program 128 can perform further processing on the final MapReduce job results and/or present the final MapReduce job results to a user via a display device.

It should be noted that since each of the datasets (input data to the mapper nodes, intermediate output data from mapper nodes, and output from reducer nodes) is assigned a unique name irrespective of the job being executed, the datasets can be retrieved from some other storage nodes other than the nominal location (e.g., the storage node that maintains the original copy of the data block, the mapper node that produces the intermediate files, etc.). For example, when a reducer node sends a map request to a mapper node at T7 in FIG. 3 this request can be served by an HTTP cache that holds the output data of the same name, generated by a (possible different) mapper node. The output data can be transmitted by the HTTP cache to a (possible different) reducer node in some previous execution of a job. In such a case, operations performed at T8 to T10 in FIG. 3 are replaced by an HTTP cache retrieving the requested data from its local storage and replying to the reducer node that requested the data (on behalf of the mapper the reducer sent the map request to).

In one embodiment, the MapReduce system utilizes HTTP for naming and retrieving all output data produced in any of its three computation stages: splitter data, mapper data, and reducer data. The use of HTTP simplifies both the naming and the caching of the data and enables the reuse of existing Content Delivery Network (CDN) or HTTP transparent proxy infrastructures for scalability and performance. The names of the data are encoded in the URI portion of the HTTP URL, while the host portion of the HTTP URL is constructed by a manner similar to the way CDNs encode the server names and their locations. This enables the use of conventional CDNs or caches in the network en-route of data transfer (e.g., between mappers to reducers), which can effectively alleviate the network traffic and reduce the latency during job executions.

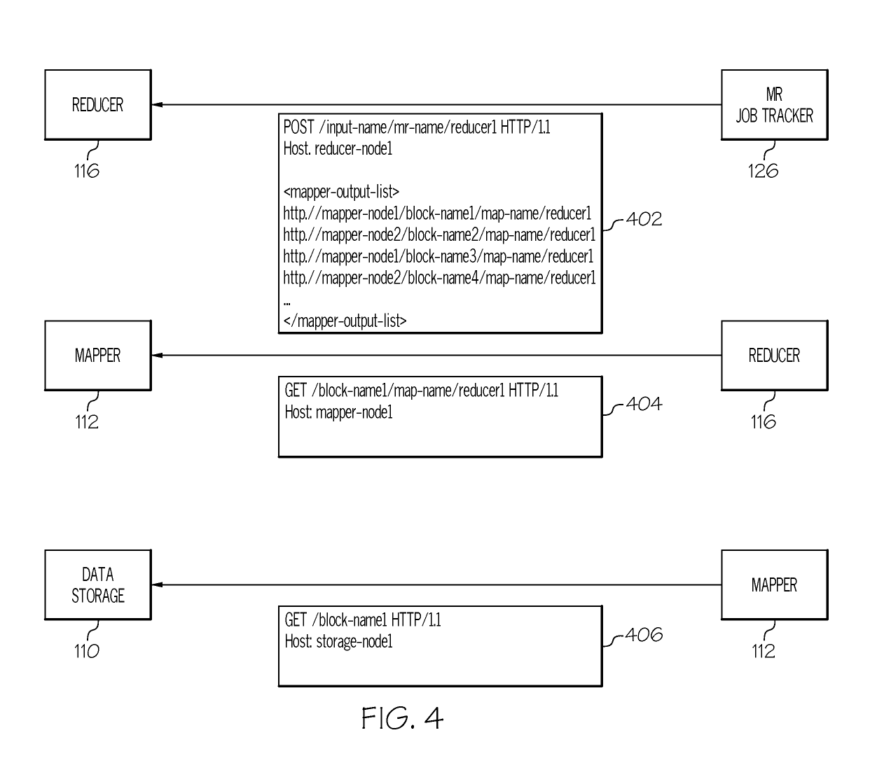

FIG. 4 shows one example of a diagram illustrating the communication model between the different components of the MapReduce system when using HTTP. It should be noted that other communication models, such as remote procedure calls (RPC) and Representational State Transfer (REST), are applicable as well. As discussed above, the use of HTTP enables caching and reuse of previously computed results. For example standard HTTP caching nodes can be introduced between the MapReduce system components. Regarding the communication between the job tracker 126 and the reducer nodes 116, 118, the job tracker 126 requests the job execution of a new MapReduce job by sending an HTTP post message 402 to each of the reducers nodes 116, 118. The URL of the post message is the name of the reduce node's output, while the body of the post message includes a list of all the URLs that the reducer node can use in order to collect the mapper outputs. Regarding the communication between the reduce nodes 116, 118 and the mapper nodes 112, 114, the reduce nodes request the task execution by sending an HTTP get message 404 to each of the mapper node. The URL of the get message is the name of the mapper's output. Regarding the communication between the mapper nodes 112, 114 and the data storage nodes 110, the mapper nodes request the input block by sending an HTTP get message 406 to a storage node. The URL of the get message is the name of the data block.

Operational Flow Diagram

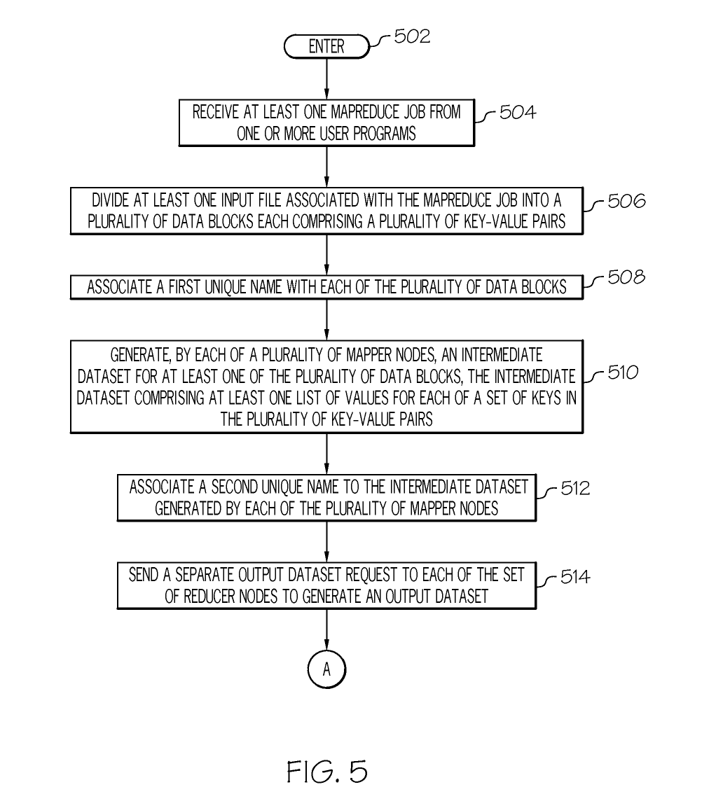

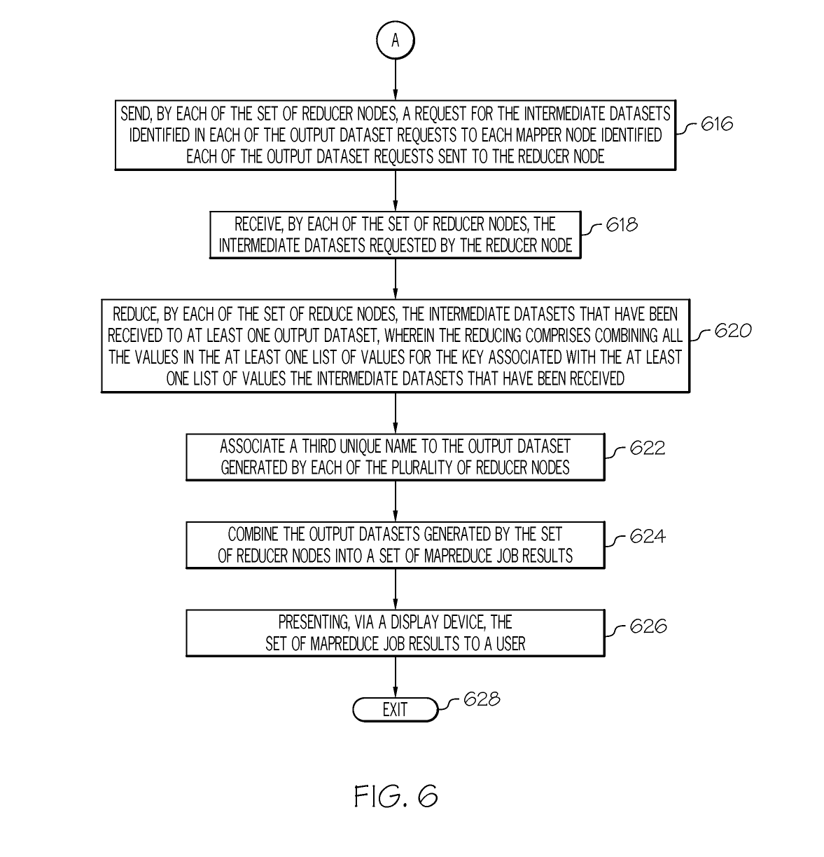

FIGS. 5-6 are operational flow diagrams illustrating one example of a process for executing a MapReduce Job according to one or more embodiments. The operational flow diagram of FIG. 5 beings at step 502 and flows directly to step 504. The MapReduce engine 124, at step 504, receives at least one MapReduce job from one or more user programs 128. The data segmentation module 132, at step 506, divides at least one input file 130 associated with the MapReduce job into a plurality of data blocks 134 each comprising a plurality of key-value pairs. The data segmentation module 132, at step 508, associates a first unique name with each of the plurality of data blocks 134.

Each of a plurality of mapper nodes 112, at step 510, generates an intermediate dataset 140 for at least one of the plurality of data blocks 134. The intermediate dataset 140 comprises at least one list of values for each of a set of keys in the plurality of key-value pairs. Each of a plurality of mapper nodes 112, at step 512 associates a second unique name to the intermediate dataset 140 generated by each of the plurality of mapper nodes 112. The second unique name is based on at least one of the first unique name associated with the at least one of the plurality of data blocks 134, a set of mapping operations performed on the at least one of the plurality of data blocks 134 to generate the intermediate dataset 140, and a number associated with a reducer node 116 in a set of reducer nodes assigned to the intermediate dataset 140. The control then flows to entry point A of FIG. 6.

The MapReduce engine 124, at step 614, sends a separate output dataset request to each of the set of reducer nodes 116 to generate an output dataset 146. Each output dataset request comprises at least the second unique name associated with the intermediate dataset 140 assigned to the reducer node 116, and an identification of the mapper node 112 that generated the intermediate dataset 140. Each of the set of reducer nodes 116, at step 616, sends a request for the intermediate datasets 140 identified in each of the output dataset requests to each mapper node 112 identified in each of the output dataset requests sent to the reducer node 116. The requests comprise at least the second unique name associated with each of the intermediate datasets 140. Each of the set of reducer nodes 116, at step 618, receives the requested intermediate datasets 140. Each of the set of reducer nodes 116, at step 620, reduces the intermediate datasets 140 that have been received to at least one output dataset 146. The reducing comprises combining all the values in the at least one list of values for the key associated with the at least one list of values the intermediate datasets 140 that have been received.

Each of the set of reducer nodes 116, at step 622, associates a third unique name to the output dataset 146 generated by each of the plurality of reducer nodes 116. The third unique name is based on a name of the input file 130, the set of mapping operations, a set of reduce operations performed on the intermediate dataset 140 to generate the output dataset 146, and the number of the reducer node 116 that generated the output dataset 146. The MapReduce engine 126, at step 624, combines the output datasets 146 generated by the set of reducer nodes 116 into a set of MapReduce job results. A user program 128, at step 626, presents the set of MapReduce job results to a user via a display device. The control flow exits at step 628.

Information Processing System

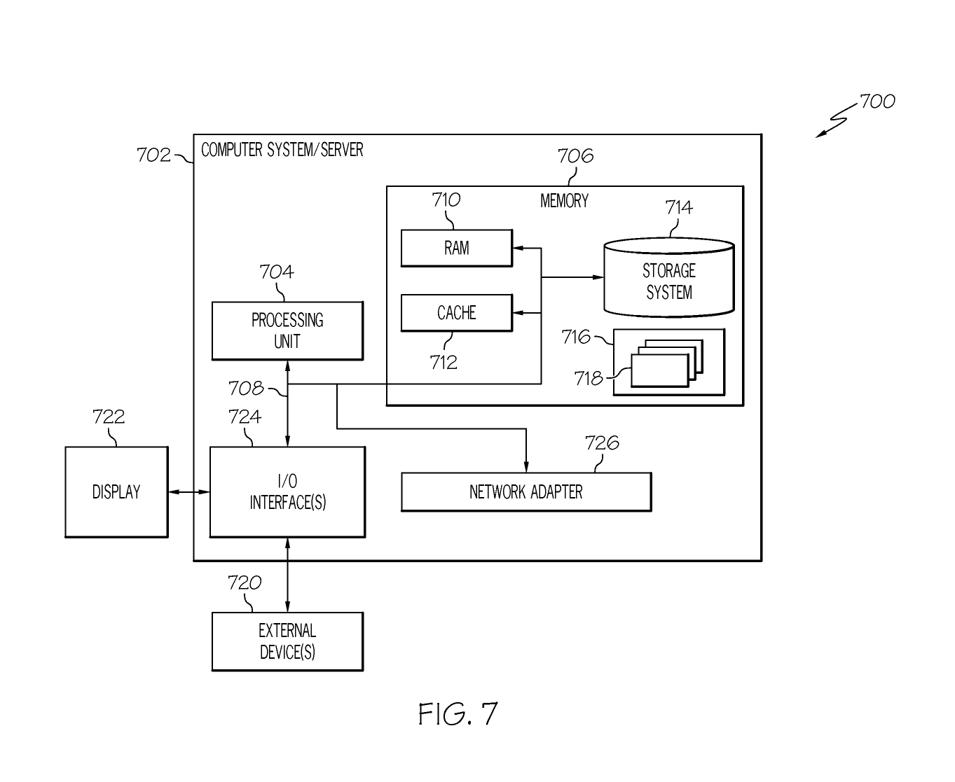

Referring now to FIG. 7, this figure is a block diagram illustrating an information processing system that can be utilized in various embodiments of the present disclosure. The information processing system 702 is based upon a suitably configured processing system configured to implement one or more embodiments of the present disclosure. Any suitably configured processing system can be used as the information processing system 702 in embodiments of the present disclosure. In another embodiment, the information processing system 702 is a special purpose information processing system configured to perform one or more embodiments discussed above. The components of the information processing system 702 can include, but are not limited to, one or more processors or processing units 704, a system memory 706, and a bus 708 that couples various system components including the system memory 706 to the processor 704.

The bus 708 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 7, the main memory 706 includes at least the MapReduce engine 124 and its components, the data segmentation module 132, the map module 136, and/or the reduce module 142 discussed above with respect to FIG. 1. Each of these components can reside within the processor 704, or be a separate hardware component. The system memory 706 can also include computer system readable media in the form of volatile memory, such as random access memory (RAM) 710 and/or cache memory 712. The information processing system 702 can further include other removable/non-removable, volatile/non-volatile computer system storage media. By way of example only, a storage system 714 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 708 by one or more data media interfaces. The memory 706 can include at least one program product having a set of program modules that are configured to carry out the functions of an embodiment of the present disclosure.

Program/utility 716, having a set of program modules 718, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules 718 generally carry out the functions and/or methodologies of embodiments of the present disclosure.

The information processing system 702 can also communicate with one or more external devices 720 such as a keyboard, a pointing device, a display 722, etc.; one or more devices that enable a user to interact with the information processing system 702; and/or any devices (e.g., network card, modem, etc.) that enable computer system/server 702 to communicate with one or more other computing devices. Such communication can occur via I/O interfaces 724. Still yet, the information processing system 702 can communicate with one or more networks such as a local area network (LAN), a general wide area network (WAN), and/or a public network (e.g., the Internet) via network adapter 726. As depicted, the network adapter 726 communicates with the other components of information processing system 702 via the bus 708. Other hardware and/or software components can also be used in conjunction with the information processing system 702. Examples include, but are not limited to: microcode, device drivers, redundant processing units, external disk drive arrays, RAID systems, tape drives, and data archival storage systems.

Non-Limiting Examples

As will be appreciated by one skilled in the art, aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for executing MapReduce jobs, the method comprising:
receiving, by a processor, at least one MapReduce job from one or more user programs;
dividing at least one input file associated with the MapReduce job into a plurality of data blocks each comprising a plurality of key-value pairs;
associating a first unique name with each of the plurality of data blocks;
generating, by each of a plurality of mapper nodes, an intermediate dataset for at least one of the plurality of data blocks, the intermediate dataset comprising at least one list of values for each of a set of keys in the plurality of key-value pairs; and
associating a second unique name with the intermediate dataset generated by each of the plurality of mapper nodes, wherein the second unique name is based on at least one of the first unique name associated with the at least one of the plurality of data blocks, a set of mapping operations performed on the at least one of the plurality of data blocks to generate the intermediate dataset, and a number associated with a reducer node in a set of reducer nodes assigned to the intermediate dataset.

2. The method of claim 1, further comprising:
sending a separate output dataset request to each of the set of reducer nodes to generate an output dataset, wherein each output dataset request comprises at least the second unique name associated with each intermediate dataset assigned to the reducer node, and an identification of each corresponding mapper node that generated each of the assigned intermediate datasets.

3. The method of claim 2, wherein each separate output dataset request is a Hyper Text Transfer Protocol based request, and wherein the second unique name within each separate output dataset request is included within a uniform resource locator of the Hyper Text Transfer Protocol based request.

4. The method of claim 2, further comprising:
sending, by each of the set of reducer nodes, a map request to each of the corresponding mapper nodes for the intermediate datasets identified in the output dataset request sent to the reducer node, wherein the map requests comprise at least the second unique name associated with each of the intermediate datasets.

5. The method of claim 4, wherein each request for the intermediate datasets identified in each of the output dataset requests is a Hyper Text Transfer Protocol based request, and wherein the second unique name within each request for the intermediate datasets is included within a uniform resource locator of the Hyper Text Transfer Protocol based request.

6. The method of claim 4, further comprising;
receiving, by each of the set of reducer nodes, each of the intermediate datasets requested by the reducer node;
reducing, by each of the set of reduce nodes, the intermediate datasets that have been received to at least one output dataset, wherein the reducing comprises combining all the values in the at least one list of values for the key associated with the at least one list of values the intermediate datasets that have been received; and
associating a third unique name to the output dataset generated by each of the set of reducer nodes.

7. The method of claim 6, wherein the third unique name is based on a name of the input file, the set of mapping operations, a set of reduce operations performed on the intermediate dataset to generate the output dataset, and the number of the reducer node that generated the output dataset.

8. The method of claim 6, further comprising:
combining the output datasets generated by the set of reducer nodes into a set of MapReduce job results; and
presenting, via a display device, the set of MapReduce job results to a user.

9. The method of claim 6, further comprising:
prior to receiving at least one of the intermediate datasets by at least one of the set of reducer nodes, receiving the map request by the corresponding mapper node associated with at least one of the intermediate datasets requested by at least one of the set of reducer nodes;
obtaining, by the corresponding mapper node, at least one of the plurality of data blocks corresponding to the at least one of the intermediate datasets based on the first unique name of the at least one of the plurality of data blocks included within the second unique name associated with the at least one of the intermediate datasets;
generating, by the corresponding mapper node based on obtaining the at least one of the plurality of data blocks, the at least one of the intermediate datasets for the at least one of the plurality of data blocks; and
sending the at least one of the intermediate datasets to the at least one of the set of reducer nodes.

10. The method of claim 9, wherein the obtaining further comprises:
sending, by the corresponding mapper node, a data block request to at least one data storage node for the at least one of the plurality of data blocks, wherein the data block request comprises at least the first unique name associated with the at least one of the plurality of data blocks, wherein the data block request is a Hyper Text Transfer Protocol based request, and wherein the first unique name within the data block request is included within a uniform resource locator of the Hyper Text Transfer Protocol based request.

11. A MapReduce system for executing MapReduce jobs, the MapReduce system comprising:
one or more information processing systems comprising memory and one or more processors communicatively coupled to the memory, the one or more processors being configured to perform a method comprising:
receiving at least one MapReduce job from one or more user programs;
dividing at least one input file associated with the MapReduce job into a plurality of data blocks each comprising a plurality of key-value pairs;
associating a first unique name with each of the plurality of data blocks;
generating, by each of a plurality of mapper nodes, an intermediate dataset for at least one of the plurality of data blocks, the intermediate dataset comprising at least one list of values for each of a set of keys in the plurality of key-value pairs; and
associating a second unique name to the intermediate dataset generated by each of the plurality of mapper nodes, wherein the second unique name is based on at least one of the first unique name associated with the at least one of the plurality of data blocks, a set of mapping operations performed on the at least one of the plurality of data blocks to generate the intermediate dataset, and a number associated with a reducer node in a set of reducer nodes assigned to the intermediate dataset.

12. The MapReduce system of claim 11, wherein the method further comprises:
sending a separate output dataset request to each of the set of reducer nodes to generate an output dataset, wherein each output dataset request comprises at least the second unique name associated with each intermediate dataset assigned to the reducer node, and an identification of each corresponding mapper node that generated each of the assigned intermediate datasets.

13. The MapReduce system of claim 12, wherein the method further comprises:
sending, by each of the set of reducer nodes, a map request to each of the corresponding mapper nodes for the intermediate datasets identified in the output dataset request sent to the reducer node, wherein the map requests comprise at least the second unique name associated with each of the intermediate datasets;
receiving, by each of the set of reducer nodes, each of the intermediate datasets requested by the reducer node;
reducing, by each of the set of reduce nodes, the intermediate datasets that have been received to at least one output dataset, wherein the reducing comprises combining all the values in the at least one list of values for the key associated with the at least one list of values the intermediate datasets that have been received; and
associating a third unique name to the output dataset generated by each of the set of reducer nodes.

14. The MapReduce system of claim 13, wherein the method further comprises:
prior to receiving at least one of the intermediate datasets by at least one of the set of reducer nodes, receiving the map request by the corresponding mapper node associated with at least one of the intermediate datasets requested by at least one of the set of reducer nodes;
obtaining, by the corresponding mapper node, at least one of the plurality of data blocks corresponding to the at least one of the intermediate datasets based on the first unique name of the at least one of the plurality of data blocks included within the second unique name associated with the at least one of the intermediate datasets;
generating, by the corresponding mapper node based on obtaining the at least one of the plurality of data blocks, the at least one of the intermediate datasets for the at least one of the plurality of data blocks; and
sending the at least one of the intermediate datasets to the at least one of the set of reducer nodes.

15. A computer program product for executing MapReduce jobs, the computer program product comprising:
a storage medium readable by a processing circuit and storing instructions for execution by the processing circuit for performing a method comprising:
receiving, by a processor, at least one MapReduce job from one or more user programs;
dividing at least one input file associated with the MapReduce job into a plurality of data blocks each comprising a plurality of key-value pairs;
associating a first unique name with each of the plurality of data blocks;
generating, by each of a plurality of mapper nodes, an intermediate dataset for at least one of the plurality of data blocks, the intermediate dataset comprising at least one list of values for each of a set of keys in the plurality of key-value pairs; and
associating a second unique name to the intermediate dataset generated by each of the plurality of mapper nodes, wherein the second unique name is based on at least one of the first unique name associated with the at least one of the plurality of data blocks, a set of mapping operations performed on the at least one of the plurality of data blocks to generate the intermediate dataset, and a number associated with a reducer node in a set of reducer nodes assigned to the intermediate dataset.

16. The computer program product of claim 15, wherein the method further comprises:
sending a separate output dataset request to each of the set of reducer nodes to generate an output dataset, wherein each output dataset request comprises at least the second unique name associated with each intermediate dataset assigned to the reducer node, and an identification of each corresponding mapper node that generated each of the assigned intermediate datasets.

17. The computer program product of claim 16, wherein the method further comprises:
sending, by each of the set of reducer nodes, a map request to each of the corresponding mapper nodes for the intermediate datasets identified in the output dataset request sent to the reducer node, wherein the map requests comprise at least the second unique name associated with each of the intermediate datasets;
receiving, by each of the set of reducer nodes, each of the intermediate datasets requested by the reducer node;
reducing, by each of the set of reduce nodes, the intermediate datasets that have been received to at least one output dataset, wherein the reducing comprises combining all the values in the at least one list of values for the key associated with the at least one list of values the intermediate datasets that have been received; and
associating a third unique name to the output dataset generated by each of the set of reducer nodes.

18. The computer program product of claim 17, wherein the third unique name is based on a name of the input file, the set of mapping operations, a set of reduce operations performed on the intermediate dataset to generate the output dataset, and the number of the reducer node that generated the output dataset.

19. The computer program product of claim 17, wherein the method further comprises:
combining the output datasets generated by the set of reducer nodes into a set of MapReduce job results; and
presenting, via a display device, the set of MapReduce job results to a user.

20. The computer program product of claim 17, wherein the method further comprises:
prior to receiving at least one of the intermediate datasets by at least one of the set of reducer nodes, receiving the map request by the corresponding mapper node associated with at least one of the intermediate datasets requested by at least one of the set of reducer nodes;
obtaining, by the corresponding mapper node, at least one of the plurality of data blocks corresponding to the at least one of the intermediate datasets based on the first unique name of the at least one of the plurality of data blocks included within the second unique name associated with the at least one of the intermediate datasets;
generating, by the corresponding mapper node based on obtaining the at least one of the plurality of data blocks, the at least one of the intermediate datasets for the at least one of the plurality of data blocks; and
sending the at least one of the intermediate datasets to the at least one of the set of reducer nodes.
